(19) United States
(12) Patent Application Publication
(10) Pub. No.: US 2011/0184750 A1
(43) Pub. Date: Jul. 28, 2011

(54) HOSPITAL INFORMATION SYSTEM

(76) Inventors: Karlheinz Dorn, Kalchreuth (DE); Vladyslav Ukis, Nurnberg (DE)

(21) Appl. No.: 12/695,182

(22) Filed: Jan. 28, 2010

(51) Int. Cl. G06Q 50/00; G06Q 10/00

(52) U.S. Cl. 705/2; 705/1.1

(57) ABSTRACT

A hospital information system including a number of distributed workstations for processing of medical data shall allow a coordinated, predictable and simulatable size-up/size-down of its systems allowing a determination of the technical and monetary consequences. To this end, in at least one embodiment, the hospital information system includes a central server unit, the workstations and the central server unit connected to each other via a data connection, wherein the central server unit includes a plurality of data interfaces, each data interface customized to provide a direct connection to one of the number of workstations, and wherein the central server unit further includes a data transfer module, an image and info nation processing module and a workflow management module.

### FIELD

At least one embodiment of the present invention generally relates to a hospital information system comprising a number of distributed workstations for processing of medical data.

### BACKGROUND

A hospital information system is a comprehensive, integrated information system designed to manage the administrative, financial and clinical aspects of a hospital or other medical installations such as small doctor's practices. These hospital information systems are usually based on a network of server and client machines and help to organize the medical treatment comprising diagnostic tasks such as radiology or other examinations as well as treatment tasks. Due to the complexity of such a hospital information system, these systems usually comprise a number of subsystems distributed on a number of computer machines interconnected in a network which provide the required features and their components.

Usually, a hospital has a number of medical imaging devices often referred to as modalities, such as computer tomography, magnetic resonance or ultrasonic devices. These modalities send recorded pictures to a PACS (Picture Archiving and Communication Systems) system for permanent storage. The PACS system is then used by imaging applications to load specific pictures and display them to a user in a suitable form. These imaging applications are then used by a departmental information system (DIS) to process and edit pictures of a specific type with the appropriate software.

The modalities, the PACS, the imaging applications and the DIS system are often connected via standard DICOM (Digital Imaging and COmmunications in Medicine) means, comprising the DICOM protocol and the DICOM modality worklist. The usage of the DICOM standard ensures that systems of different manufacturers may be obtained by a hospital and work seamlessly with each other.

The abovementioned system ensures a certain interoperability between the several IT (information technology) systems of a hospital. However, a standardized solution architecture for these IT systems does not exist. A limited integration of the separate systems is done via the DICOM standard for imaging appliances or via the HL 7 (Health Level 7) standard for non-imaging appliances.

A controlled, concise size-up/size-down of the separate systems depending on the actual requirements in the hospital environment is currently not provided. A complicated coordination of systems of different manufacturers is often required and it is not predictable whether the hospital information system will be able to cope with an increased number of modalities, an increased number of examinations involving modalities, an increased number of requests to the PACS or DIS systems, or the deployment requirements for imaging applications, such as thin client, rich thin client, rich client or fat client deployment or a combination thereof.

The impact of changes to one of the abovementioned systems on the hospital information system is unpredictable. Consequently, the cost incurred by these changes is just as unpredictable. The change has to be implemented to monitor its consequences, i.e. a time-consuming trial-and-error method is usually required. Therefore, the integration of the systems present in the hospital into a solution such as a hospital information system is an error-prone, programming-intensive and costly process which cannot be simulated before the actual realization.

### SUMMARY

Due to the above shortcomings of the prior art, hospital information systems therefore lack flexibility regarding the implementation of changes to their several systems and subsystems and the predictability of the technical and monetary consequences of these changes.

Accordingly, at least one embodiment of the present invention provides a hospital information system that allows a coordinated, predictable and simulatable size-up/size-down of its systems allowing a determination of the technical and monetary consequences.

Further, at least one embodiment of the present invention provides an integrated hospital information system that still allows to purchase and integrate systems and subsystems of different manufacturers and combine them within a standard DICOM environment.

Additionally, at least one embodiment of the present invention provides a hospital information system that allows a simulation of the hospital architecture to predict its technical properties before and after the implementation of changes and further allows a coordinated implementation of these changes.

Still further, at least one embodiment of the invention provides a hospital information system that is suitable for small and very large hospitals and therefore has a certain scalability that allows the removal of certain systems for small hospitals or an upgrade to the required capacity for large hospitals.

To the accomplishment of the foregoing and related ends, the invention then comprises the features hereinafter fully described and particularly pointed out in the claims, the following description and drawings setting forth in detail certain illustrative embodiments of the invention, these being indicative, however, of but several of the various ways in which the principles of the invention may be employed.

### BRIEF DESCRIPTION OF THE DRAWINGS

The present invention will become more fully understood from the detailed description of example embodiments given hereinbelow and the accompanying drawings, which are given by way of illustration only and are thus not limitive of the present invention, and wherein:

FIG. 1 illustrates a schematic representation of an embodiment of the hospital information system according to the invention;

FIG. 2 shows a simulation module according to an embodiment of the present invention;

FIG. 3 shows a data interface to a PACS service module;

FIG. 4 shows the connection of the PACS service module to a central server unit;

FIG. 5 shows a data interface to a report service module;

FIG. 6 shows the connection of the report service module to the central server unit;

FIG. 7 shows a data interface to a departmental information service module;

FIG. 8 shows a schematic representation of another embodiment of the hospital information system comprising a plurality of hospital departments.

FIG. 9 shows a schematic representation of the connection of client machines of each hospital department to the central server unit.

### DETAILED DESCRIPTION OF THE EXEMPLARY EMBODIMENTS OF THE PRESENT APPLICATION

Various example embodiments will now be described more fully with reference to the accompanying drawings in which only some example embodiments are shown. Specific structural and functional details disclosed herein are merely representative for purposes of describing example embodiments. The present invention, however, may be embodied in many alternate forms and should not be construed as limited to only the example embodiments set forth herein.

Accordingly, while example embodiments of the invention are capable of various modifications and alternative forms, embodiments thereof are shown by way of example in the drawings and will herein be described in detail. It should be understood, however, that there is no intent to limit example embodiments of the present invention to the particular forms disclosed. On the contrary, example embodiments are to cover all modifications, equivalents, and alternatives falling within the scope of the invention. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example embodiments of the present invention. As used herein, the term “and/or,” includes any and all combinations of one or more of the associated listed items.

The terminology used herein is for the purpose of describing particular embodiments only and is not intended to be limiting of example embodiments of the invention. As used herein, the singular forms “a,” “an,” and “the,” are intended to include the plural forms as well, unless the context clearly indicates otherwise. As used herein, the terms “and/or” and “at least one of” include any and all combinations of one or more of the associated listed items. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

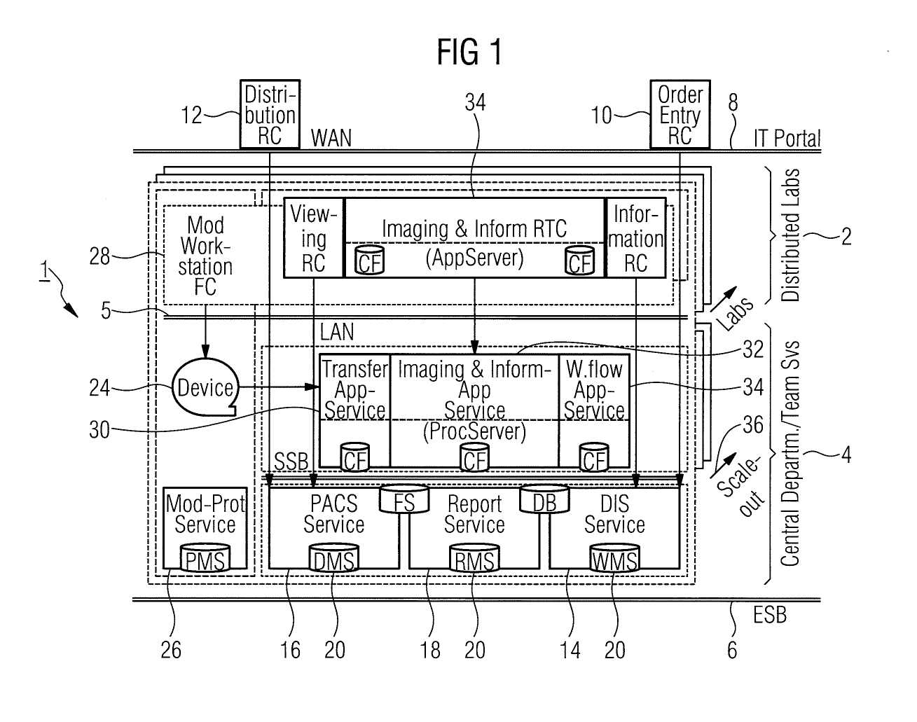

Referring to the drawing, FIG. 1 shows a schematic illustration of a hospital information system 1. The hospital information system 1 is designed according to a generic hospital solution architecture customizable to the needs of hospitals of arbitrary size and requirements.

FIG. 1 is divided in two horizontal parts, the upper part representing parts of the distributed workstations 2 of the hospital information system 1 that are situated at distributed labs or departments of the hospital. The lower part comprises parts of the central server unit 4 that provides central departmental services to the hospital environment that are shared by all departments.

The distributed labs and central departmental services are physically separated and only connected via a local area network (LAN) 5.

The enterprise service bus (ESB) 6 shown in FIG. 1 is a reliable and error-tolerant communication system that enables the exchange of information between different hospitals or a hospital and its satellite sites.

The IT portal 8 of the hospital is an application realized via web technology. It is used by the hospital to fulfil order entry 10 and distribution 12 requests.

Order entry 10 is an application that is used to register patients arriving at the hospital and plan the necessary medical examinations (orders). The order entry 10 application stores the data within the departmental information service (DIS) 14 being part of the central server unit 4. The DIS may be obtained by the hospital from a suitable manufacturer. An important aspect here is that both order entry 10 application and DIS 14 are optional. A small doctor's practice may for example dispense entirely with order entry 10 and DIS 14 if examinations are conducted there spontaneously and ad-hoc.

The distribution 12 application is used to distribute results of the examinations planned with the order entry 10 application and further applications described in further detail hereinbelow. These results are mostly DICOM objects: images or reports. The results may be distributed to either satellite sites of the same hospital or even other hospitals. The distribution 12 application uses the PACS service 16 to fetch DICOM objects to be distributed. Again an important aspect is that both distribution 12 application and PACS service 16 are optional. A small doctor's practice may for example dispense entirely with distribution 12 application and PACS service 16 if it is only working locally and does not produce a large number of images, so that these results may simply be stored in a local file system without the use of PACS.

DIS 14, PACS service 16 and report service 18 for the preparation of medical reports are optional and may be purchased from different suppliers according to the needs of the specific hospital environment. Each of these services comprises a database 20 to store and retrieve information relevant to the respective service. The services are accessed by the system service bus (SSB) 22. The SSB 22 is a local communication system. It relays messages locally between the systems of the central server unit 2. In contrast to the ESB 6, no messages are communicated to the exterior.

So far, the order entry 10 application planning examinations, and the distribution 12 application distributing the results of the conducted examinations have been described. In the following, the parts of the hospital information system 1 that are actually relevant for conduction the examinations will be described.

FIG. 1 shows a device 24 which may be any medical imaging device or modality such as a computer tomography device, magnetic resonance device, ultrasonic device etc. A modality fetches its measurement protocols from the protocol service 26. The protocol service 26 is optional, however it facilitates examinations at the respective modality since the staff does not need to create and conduct measurement protocols on his own.

The medical staff initiates an examination at the respective modality by using specific exam applications that are installed at the modality workstation 28. These applications are realized as a fat client (FT), i.e. they provide rich functionality independent of the central server unit 4. A distribution of the application layers over the LAN network 5 is not advantageous in this case because the application is only used on the respective modality workstation 28 and should also stay functional during a malfunction of the LAN 5.

A hospital may comprise an arbitrary number of distributed workstations 2 like modality workstations 28 with devices 24. The general picture of the architecture depicted in FIG. 1 remains unchanged.

After recording by the modality, images are sent to the transfer application service 30 shown in FIG. 1. The transfer application service 30 receives the images and stores them locally. The images may then be used by imaging applications as input. The transfer application service also provides means for sending images on request by an application.

The imaging and information application service 32 comprises a number of imaging and information applications for processing and editing of medical images and patient information. Here, the central server unit 4 only comprises the business logic of these applications. The presentation logic part of the imaging and information applications 34 is executed at the distributed workstation 2. The distribution of the different application layers over the LAN 5 is in this case advantageous because it allows doctors to use the applications from any arbitrary machine in the lab: the doctor starts the presentation logic on an arbitrary machine and the presentation logic establishes a connection to the business logic by itself.

Apart from the transfer application service 30 and the imaging and information application service 32, the central server unit 4 also comprises a workflow application service 34. This service connects single medical applications or tasks to taskflows. Within a taskflow, the data flow through tasks is determined and automated via predefined port connections of the tasks. Here, a single task may be used in a plurality of taskflows.

The workflow application service 34 allows the definition of specific tasks that are common to all teams of all sites of a hospital. The general structure of a taskflow is: order check, plan scheduling, perform, process, document, distribute. However, the defined tasks do not have to be executed together, they may of course be executed seperately, without being part of a superpositioned taskflow. A monitoring cockpit can be provided for continuous monitoring of the state of execution of the different tasks.

The transfer application service 30, the imaging and information application service 32 and the workflow application service 34 are often subject to a high number of requests. This is the case because all departments of the hospital use these services simultaneously. Therefore, the architecture of the hospital information system 1 according to FIG. 1 allows to distribute the backends of these services on multiple servers of a server farm. This procedure is called scale-out 36. Depending on the work load profile of a hospital, a scale-out 36 procedure of a suitable size may be chosen. The scale-out 36 of the backends has no influence on the respective frontends. The only recognizable change for the user is an increased performance during operation of the application.

Due to the open architecture, different systems shown in FIG. 1 may be hosted by different hosts to reduce the total cost of ownership for the hospitals. This allows to reduce the number of required IT staff for installation and maintenance.

The described architecture also includes a background jobs management concept. Within this concept, jobs may be started with controlled access to resources such as CPU, GPU, memory and network managed via plugins.

The generic structure of the proposed architecture allows to picture an arbitrary hospital with any number of departments and satellite sites. Therefore, it is possible to simulate specific architectures offline. A successful simulation not only allows to determine the technical requirements of the hospital information system 1 but also allows a financial evaluation.

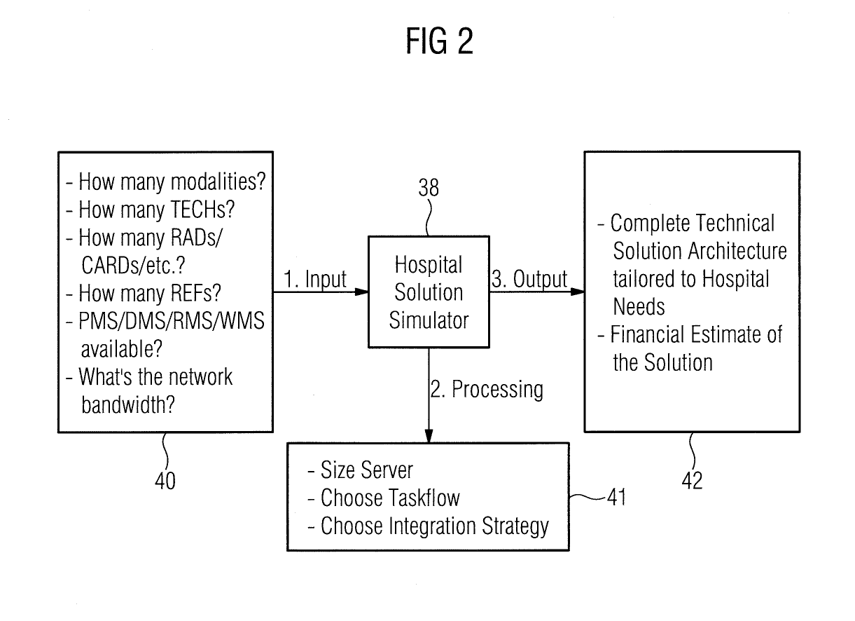

The hospital solution simulator depicted in FIG. 2 is based on the architecture shown in FIG. 1 and may for example be realized as a simulation module 38. The simulator receives diverse information as input 40 such as the number and type of modalities to be used, the number of technicians employed in the hospital, the number of radiologists, cardiologists and other specific medical personnel employed in the hospital, the number of referring physicians to be connected to the system, the possible existence of pre-installed protocol, PACS, report or DIS services in the hospital, the available network bandwidth in the hospital etc.

Based on this input 40 the simulator module 38 processes 41 the data and drafts a complete solution architecture for the hospital as output 42. Depending on the number of users, a certain specific server with a suitable scale-out option or a respective alternative cheaper solution based on virtualization is suggested. Depending on the doctor's specific professions in the hospital, suitable taskflows built from single specified tasks are chosen. Depending on the existing infrastructure of the hospital, a suitable strategy for the integration of the existing systems and those of the solution are chosen.

The result is a complete technical solution architecture for the hospital. Based on the cost of the separate parts and components of the solution, the simulator module 38 evaluates the overall cost of the solution. The simulator module 38 may also be used to simulate and evaluate changes to an existing hospital information system 1. A size-up or size-down of the present solution can be easily conducted because of the flexible solution architecture according to the invention.

Any change is simulated by the simulator module 38 incorporating all other systems of the solution. The underlying solution architecture allows the realization of these coordinated changes.

The hospital information system 1 designed according to the invention also allows the creation, management and operation of virtual, disease-oriented teams in a multi-site hospital environment, such that an arbitrary number of hospital sites may be added by configuration. Every site may contain an arbitrary number of modalities of arbitrary type such as computer tomography, magnetic resonance etc.

Each site is designed according to the solution depicted to FIG. 1 and comprises a short duration memory for fast access to image data by the respective site or workstation. Each site further comprises an imaging and information application service, a transfer application service and a workflow application service. This allows the user to distribute the applications by rich thin client (RTC) deployment to all sites of the hospital. These RTC applications are zero admin deployable and may comprise arbitrary imaging applications. Fat client deployment is also possible.

The imaging and information application, transfer application service and workflow application services are scalable according to the workload within the hospital environment. Scalability is achieved through accordant load compensation. Both scale-up (upgrade of the hardware resources within the central server unit 4) and scale-out (creation of a server farm with several physical servers) are possible.

RTC applications may run parallel to applications of other manufacturers on the client machines. These applications may also be invoked by a RTC application through transmittal of a parameterized string. Such loose integration is possible through so-called call-ups. At least the following call-ups are possible: image call-up, report call-up, order call-up, plan call-up and schedule call-up.

Every site may comprise a PACS service 20 for central storage of data to avoid unnecessary copying of data. The modalities 24 send data to the PACS, from where they are fetched and processed by the application server before distribution in compressed form to the RTC clients.

Each site may comprise a report service 18 for creation of diagnostic reports that are stored within the PACS system similar to medical images. Every site may further comprise a DIS service 14 for support of the procedures in the respective site (procedures at each site may be different dependent on the specific expertise of the department such as radiology, cardiology etc.).

The application service may also be extended with applications of at least the following types: examination applications of arbitrary modalities (e.g. card-CT, card-MR, card-US; lung-CT, lung-MR, lung-AX etc.), 2D PACS applications and DIS reporting and information applications. These applications correspond to the services shown in FIG. 1.

PACS 16, report 18 and DIS 14 services may be purchased from different manufacturers and my be connected by customized data interfaces. The connection is done by implementation of each data interface by the manufacturer. Data exchange is based on the respective domain standard.

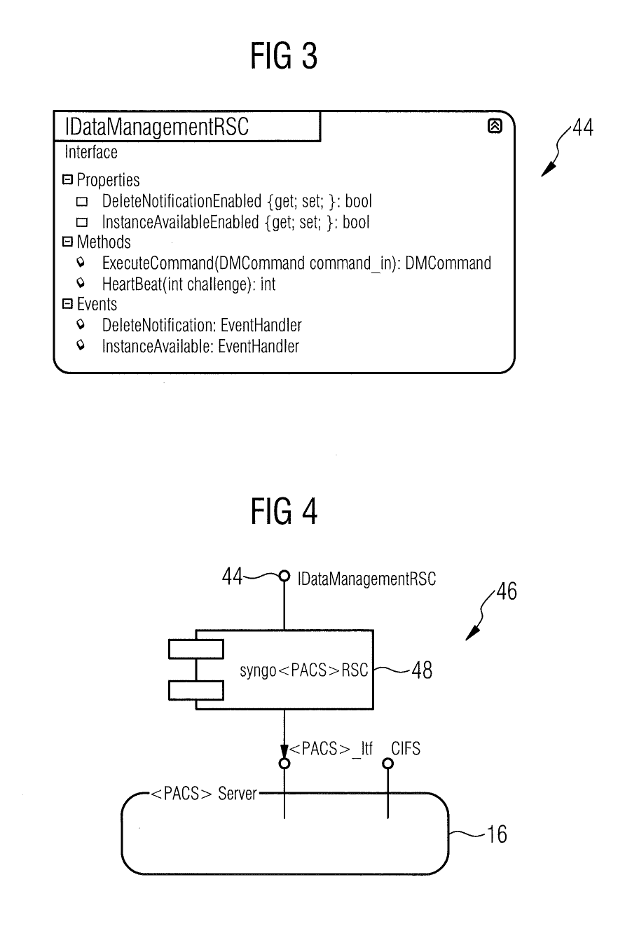

The data interface for the PACS service IDataManagementRSC 44 is shown in FIG. 3. DMCommands for the method ExecuteCommand are as follows:
InstanceAvailable
DeleteNotification
Query
Lock
Unlock
ContextFolderManagement
   Create
   Delete
   Exists
   GetAll
   GetLocation
   GetType
UnSafeGetFileSet
Publish
DeleteCommands
   GetDeleteCandidates
   MarkAsDeleted
   PurgeDeleted
ResolveNlsMessagld
GetDevicePropertyCommand
UpdatePlRAttributesCommand
UpdateAttributesCommand
SetWorkState

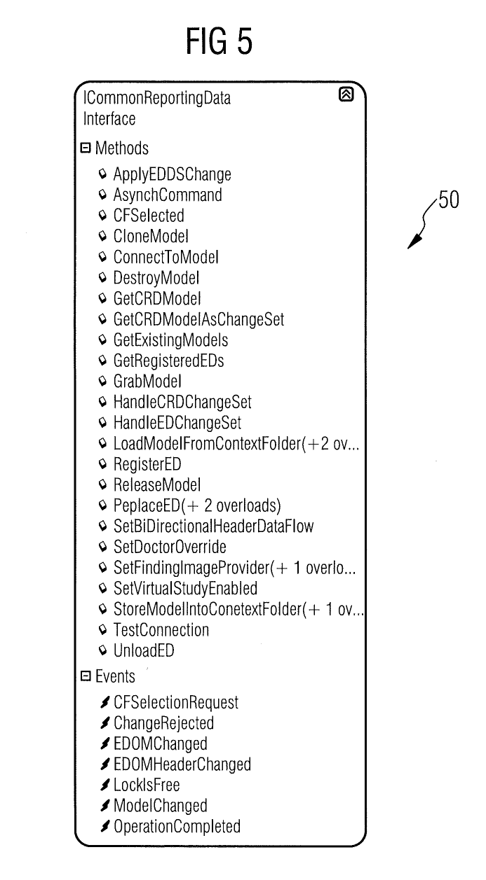

Each DMCommand is a key/value pair. A PACS of any vendor may therefore be connected by the PACS connection 46 shown in FIG. 4: An RSC (remote service component) 48 is implemented with the interface IDataManagementRSC 44 and communicates with the PACS service 16.

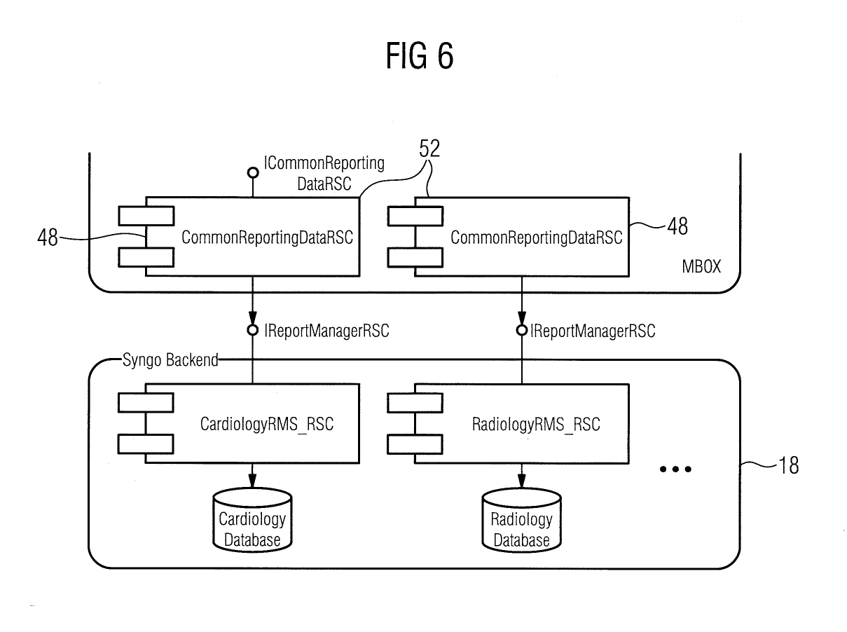

The data interface for the report service ICommonReportingData 50 is shown in FIG. 5. FIG. 6 shows how the interface ICommonReportingData 50 is implemented with different configurations 52 separately for each hospital department and their respective RSCs 48. Communication with the respective parts of the report service 18 is established from there.

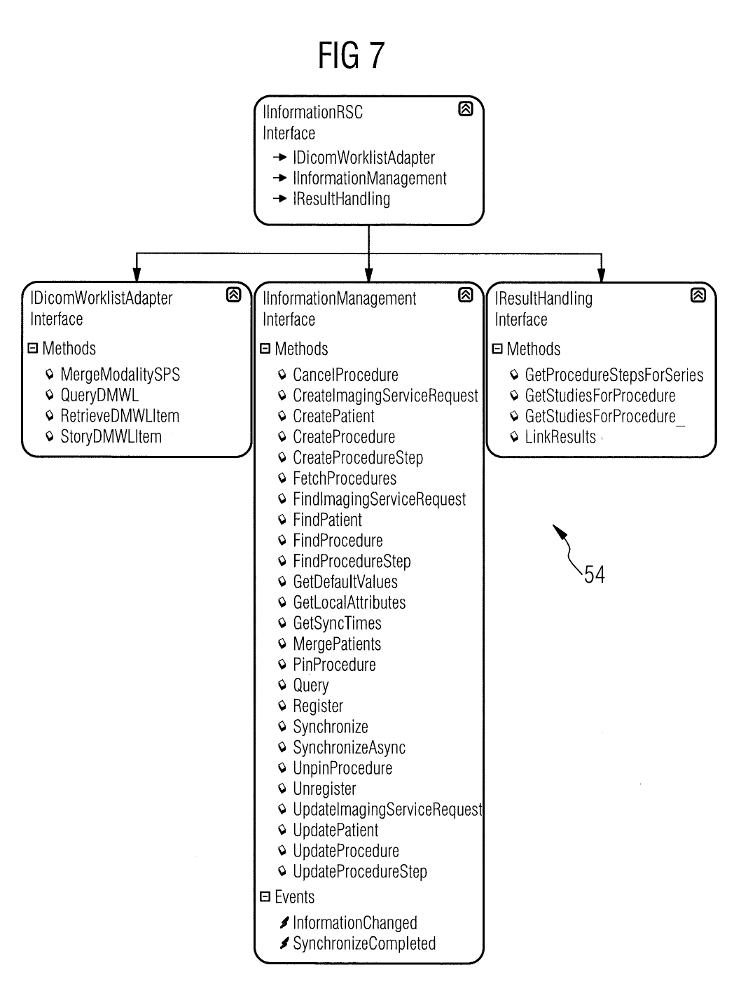

The data interface for the DIS IInformationRSC 54 is shown in FIG. 7. An implementation of the interface may query an information system with DICOM means. For example, a modality worklist to be executed in a department can be queried.

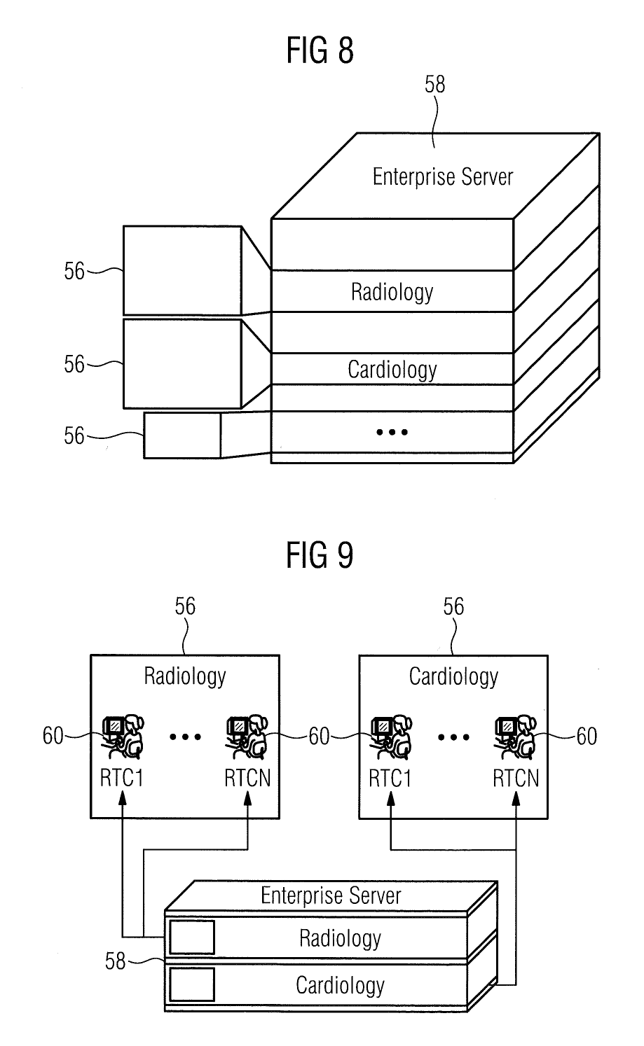

FIG. 8 shows how the model depicted in FIG. 1 may be instanced virtualized for a plurality of departments 56 and deployed on a single enterprise hospital server 58. This is possible due to the multitenancy of the software architecture. Each department 56 is modelled and configured according to its already existing systems. FIG. 9 shows the distribution of the RTC clients 60 in each department 56. Alternatively, a single server for each department may of course also be used.

The introduction of a solution architecture for a hospital information system 1 according to the invention has the general advantage that the systems of the solution are adjusted to each other. This is possible even in the case that systems are purchased from different manufacturers.

The generic hospital solution architecture has the additional advantage that it may be applied to hospitals of arbitrary size even including multi-site and tele-department environments. It includes inherent size-up/size-down possibilities. This also allows a simulation of solutions for hospitals and their financial evaluation, even for changes in existing solution, in contrast to the prior art that does not allow predictions of such kind in the case of upgrades/downgrades of existing systems.

The hospital information system architecture according to the invention allows a complete and thorough pre-planning of the system environment including technical and personnel aspects. Based on the parameters of the deployment environment a model of the central hospital server unit is created in order to evaluate whether the software systems desired by the user are able to run in the defined deployment environment.

Furthermore, the systems to be deployed on the server such as transfer service, imaging and information application service, workflow service, protocol service, PACS service, report service and DIS are chosen. Due to the open nature of the architecture according to the invention, already existing systems can be easily integrated into the new solution.

A latitude of modification, change and substitution is in-tended in the foregoing disclosure and in some instances some features of the invention will be employed without a corresponding use of other features. Accordingly, it is appropriate that the appended claims be construed broadly and in a manner consistent with the spirit and scope of the invention herein.

The patent claims filed with the application are formulation proposals without prejudice for obtaining more extensive patent protection. The applicant reserves the right to claim even further combinations of features previously disclosed only in the description and/or drawings.

The example embodiment or each example embodiment should not be understood as a restriction of the invention. Rather, numerous variations and modifications are possible in the context of the present disclosure, in particular those variants and combinations which can be inferred by the person skilled in the art with regard to achieving the object for example by combination or modification of individual features or elements or method steps that are described in connection with the general or specific part of the description and are contained in the claims and/or the drawings, and, by way of combineable features, lead to a new subject matter or to new method steps or sequences of method steps, including insofar as they concern production, testing and operating methods.

References back that are used in dependent claims indicate the further embodiment of the subject matter of the main claim by way of the features of the respective dependent claim; they should not be understood as dispensing with obtaining independent protection of the subject matter for the combinations of features in the referred-back dependent claims. Furthermore, with regard to interpreting the claims, where a feature is concretized in more specific detail in a subordinate claim, it should be assumed that such a restriction is not present in the respective preceding claims.

Since the subject matter of the dependent claims in relation to the prior art on the priority date may form separate and independent inventions, the applicant reserves the right to make them the subject matter of independent claims or divisional declarations. They may furthermore also contain independent inventions which have a configuration that is independent of the subject matters of the preceding dependent claims.

Further, elements and/or features of different example embodiments may be combined with each other and/or substituted for each other within the scope of this disclosure and appended claims.

Still further, any one of the above-described and other example features of the present invention may be embodied in the form of an apparatus, method, system, computer program, computer readable medium and computer program product. For example, of the aforementioned methods may be embodied in the form of a system or device, including, but not limited to, any of the structure for performing the methodology illustrated in the drawings.

Even further, any of the aforementioned methods may be embodied in the form of a program. The program may be stored on a computer readable medium and is adapted to perform any one of the aforementioned methods when run on a computer device (a device including a processor). Thus, the storage medium or computer readable medium, is adapted to store information and is adapted to interact with a data processing facility or computer device to execute the program of any of the above mentioned embodiments and/or to perform the method of any of the above mentioned embodiments.

The computer readable medium or storage medium may be a built-in medium installed inside a computer device main body or a removable medium arranged so that it can be separated from the computer device main body. Examples of the built-in medium include, but are not limited to, rewriteable non-volatile memories, such as ROMs and flash memories, and hard disks. Examples of the removable medium include, but are not limited to, optical storage media such as CD-ROMs and DVDs; magneto-optical storage media, such as MOs; magnetism storage media, including but not limited to floppy disks (trademark), cassette tapes, and removable hard disks; media with a built-in rewriteable non-volatile memory, including but not limited to memory cards; and media with a built-in ROM, including but not limited to ROM cassettes; etc. Furthermore, various information regarding stored images, for example, property information, may be stored in any other form, or it may be provided in other ways.

Example embodiments being thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A hospital information system, comprising:
a number of distributed workstations to process medical data; and
a central server unit, said number of distributed workstations and said central server unit being connected via a data connection, said central server unit including
a plurality of data interfaces, each of the plurality of data interfaces being customized to provide a direct connection to one of said number of distributed workstations,
a data transfer module,
an image and information processing module, and
a workflow management module.

2. The hospital information system of claim 1, wherein at least one of said number of distributed workstations comprises a medical imaging device.

3. The hospital information system of claim 1, wherein at least one of said number of distributed workstations includes a PACS archive.

4. The hospital information system of claim 1, wherein at least one of said number of distributed workstations includes a medical image data processing device.

5. The hospital information system of claim 1, wherein at least one of said number of distributed workstations includes a data displaying device.

6. The hospital information system of claim 1, wherein said central server unit includes local communication system including a number of interfaces to optional service modules.

7. The hospital information system of claim 6, wherein said local communication system includes an interface to a PACS service module.

8. The hospital information system of claim 6, wherein said local communication system includes an interface to a report service module.

9. The hospital information system of claim 6, wherein said local communication system includes an interface to a departmental information service module.

10. The hospital information system of claim 1, wherein said central server unit includes a plurality of server machines.

11. The hospital information system of claim 1, further comprising a simulator module with means for determining technical specifications of said hospital information system based on at least one of technical and personnel related information.

12. The hospital information system of claim 1, further comprising a simulator module with at least one device to determine technical specifications of said hospital information system based on at least one of technical and personnel related information.
